(19) United States
(12) Patent Application Publication
(10) Pub. No.: US 2023/0287847 A1
(43) Pub. Date: Sep. 14, 2023

(54) METHODS AND APPARATUSES FOR REDUCING ENGINE NOISE

(71) Applicant: The Government of the United States of America, as represented by the Secretary of the Navy, Washington, DC (US)

(72) Inventors: Junhui Liu, Washington, DC (US); Ephraim Gutmark, Cincinnati, OH (US); Allan Aubert, Washington, DC (US)

(21) Appl. No.: 18/141,586

(22) Filed: May 1, 2023

Related U.S. Application Data
(63) Continuation of application No. PCT/US21/61784, filed on Dec. 3, 2021.
(60) Provisional application No. 63/121,189, filed on Dec. 3, 2020.

(51) Int. Cl. F02K 1/82

(52) U.S. Cl. CPC F02K 1/827; F05D 2240/127; F05D 2240/128; F05D 2260/96

(57) ABSTRACT

Methods and apparatuses for reducing engine noise provided. In one embodiment, an apparatus is provided that includes a plurality of seals and flaps that are interconnected and circumferentially arranged. Also included are a plurality of micro-vortex generator pairs respectively disposed in a circumferential manner on an interior surface of the seals. Each micro-vortex generator pair includes a first and second micro-vortex generator. In another embodiment, a method of generating a plurality of vortices in a nozzle section of a jet engine is provided. A plurality of micro-vortex generator pairs are provided on a plurality of seal surfaces of the nozzle section, respectively. The micro-vortex generator pairs are constructed to generate two vortices adjacent to an interior surface of the nozzle section and extending in a direction towards a nozzle exit. The interaction between the nozzle flow and the micro-vortex generator pairs greatly modify the shock cell structure within the nozzle section and the turbulence structure in the jet plume.

### BACKGROUND

### Field of the Invention

The present application relates generally to methods and apparatuses for reducing engine noise.

### Description of Related Art

Jet engines are unquestionably one of the most important inventions of the 20^{th} century. Jet engines revolutionized air travel by allowing airplanes to travel farther and faster than ever before, even exceeding the speed of sound. However, jet engines have their drawbacks. One of those drawbacks is the high noise levels they create, especially from engines designed for supersonic flight. Jet engine noise is a safety risk for ground personnel who are often in close proximity to the aircraft when an aircraft is taking off. It is no surprise then that the U.S. Department of Veterans Affairs has paid significant amounts of money in disability claims that arise from exposure to aircraft engine noise.

Research has been done in the area of reducing engine noise for supersonic aircraft. One part of the engine that has received attention, is the exhaust nozzle. Four approaches to nozzle modifications for noise reduction that have been considered are: corrugated engine seals, chevrons, fluidic injection, and fluidic inserts. Each of these have their drawbacks. Corrugated engine seals are effective in reducing engine noise, but require a substantial change to the engine nozzle design, with associated weight, cost, and engine performance impacts. Chevrons attached to the nozzle lip surface can also reduce engine noise, but have not yet been developed to the point of being reliably effective, durable, and cost effective for fielding to a production aircraft. The fluidic injection and fluidic insert approaches are also capable of reducing engine noise, but require an extra supply of fluid that makes these technologies difficult and expensive to retrofit to existing engines. Thus, it would be desirable to have a means of reducing engine noise that can be retrofitted to existing nozzles as well as incorporated into new nozzles.

### SUMMARY OF THE INVENTION

One or more of the above limitations may be diminished by structures and methods described herein.

In one embodiment, an apparatus for directing air from an engine is provided. The apparatus includes a plurality of seals, flaps and micro-vortex generator pairs. The plurality of seals and the plurality of flaps are interconnected and circumferentially arranged. The plurality of micro-vortex generator pairs are respectively disposed in a circumferential manner on an interior surface of the plurality of seals, wherein each of the plurality of micro-vortex generator pairs includes: a first micro-vortex generator and a second micro-vortex generator.

In another embodiment, a method of generating a plurality of vortices in a nozzle section of a jet engine is provided. A plurality of micro-vortex generator pairs are provided on a plurality of seal surfaces of the nozzle section, respectively. Each of the plurality of micro-vortex generator pairs is constructed to generate two vortices adjacent to an interior surface of the nozzle section and extending in a direction towards a nozzle exit. The vortices generated by the plurality of micro-vortex generator pairs modify shock cell formation within the nozzle section.

### BRIEF DESCRIPTION OF THE DRAWINGS

The teachings claimed and/or described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A is a perspective exploded view of a typical turbofan jet engine 100 that includes an afterburner and is designed for supersonic flight;

FIG. 1B is a cross-sectional view of engine 100 taken along axis A in FIG. 1A;

FIG. 1C is a cross-sectional view of the nozzle section 114 in FIG. 1B;

FIG. 2A is a cross-sectional view of a nozzle section 114 showing time-averaged Mach numbers for a supersonic flow;

FIG. 2B is a plan view showing noise levels to the port side aft of an aircraft preparing for takeoff;

FIG. 3A is a perspective view of a divergent portion 130 of a nozzle section 114, according to one embodiment;

FIG. 3B is a perspective view of a divergent portion 130 of a nozzle section 114, according to another embodiment;

FIG. 3C is a two-dimensional representation of a portion of nozzle section 114, as shown in FIG. 3D;

FIG. 3D is a perspective view of a divergent portion of 130 of nozzle section 114 according to one embodiment;

FIG. 4A is a side view of an exemplary micro-vortex generator;

FIG. 4B is another side view of the exemplary micro-vortex generator;

FIG. 4C is a side view of yet another exemplary micro-vortex generator;

FIG. 4D is another side view of the yet another exemplary micro-vortex generator;

FIG. 4E is a side view of a still further exemplary micro-vortex generator;

FIG. 4F is a side view of an even further exemplary micro-vortex generator;

FIG. 4G is a side view of another exemplary micro-vortex generator;

FIG. 4H is a side view of yet another exemplary micro-vortex generator;

FIG. 4I is a side view of a further exemplary micro-vortex generator;

FIG. 4J is a side view of a still further exemplary micro-vortex generator;

FIG. 5A is a perspective view of the portion of nozzle section 114 shown in box 301 in FIG. 3A;

FIG. 5B is a perspective view of the same portion of nozzle section 114 depicted in FIG. 5A, but viewed from the opposite side;

FIG. 5C is a perspective view of a micro-vortex generator pair according to another embodiment;

FIG. 5D is another perspective view of the micro-vortex generator pair shown in FIG. 5C, but viewed from an opposite side;

FIGS. 5E-F are upstream and downstream perspective views of a micro-vortex generator pair according to another embodiment.

FIGS. 5G-H are upstream and downstream perspective views of a micro-vortex generator pair according to yet another embodiment.

FIG. 6A is a perspective view of a divergent portion 130 of nozzle section 114, according to another embodiment;

FIG. 6B is a perspective view of a divergent portion 130 of nozzle section 114, according to yet another embodiment;

FIG. 7A is a perspective view of a divergent portion 130 of nozzle section 114, according to a further embodiment;

FIG. 7B is a perspective view of a divergent portion 130 of nozzle section 114, according to a still further embodiment;

FIG. 8A is a perspective view of a micro-vortex generator pair according to the embodiment shown in FIG. 7A;

FIG. 8B is another perspective view of the micro-vortex generator pair shown in FIG. 8A from the opposite side;

FIGS. 8C-D are upstream and downstream perspective views of another micro-vortex generator pair according to another embodiment.

FIG. 9A is a cross-sectional view of a nozzle section 114 according to one embodiment showing instantaneous Mach numbers;

FIG. 9B is another cross-sectional view of a nozzle section 114 according to another embodiment showing instantaneous Mach numbers;

FIG. 9C is a cross-sectional view of the flow depicted in FIG. 9B. at the nozzle exit looking upstream showing vortices generated by micro-vortex generators;

FIG. 9D is a cross-sectional view of another flow at the nozzle exit in a nozzle section that does not include micro-vortex generators;

FIG. 9E is a side view of a nozzle section according to one embodiment and a plume emanating therefrom;

FIG. 9F is a side view of a conventional nozzle section and a plume emanating therefrom;

FIG. 9G is a side view of a nozzle section according to one embodiment showing turbulent kinetic energy distributions downstream from the nozzle exit;

FIG. 9H is a side view of a conventional nozzle section showing turbulent kinetic energy distributions downstream from the nozzle exit;

FIG. 10A is a plot of noise reduction under takeoff conditions where the angle a is varied;

FIG. 10B is a side view of a block diagram illustrating an engine 100 and a setup for measuring noise from engine 100;

FIG. 11 is a plot of noise reduction for a certain nozzle pressure ratio where the angle b is varied;

FIG. 12 is a plot of noise reduction for a certain nozzle pressure ratio where a distance between the pair of micro-vortex generators is varied;

FIG. 13 is a plot of noise reduction for a certain nozzle pressure ratio where a height of the micro-vortex generators is varied;

FIG. 14A is a perspective view of a divergent portion 130 of nozzle section 114, according to another embodiment where a first and second plurality of micro-vortex generator pairs are provided; and

FIG. 14B is a perspective view of a divergent portion 130 of nozzle section 114, according to yet another embodiment where a first and second plurality of micro-vortex generator pairs are provided.

Different ones of the Figures may have at least some reference numerals that are the same in order to identify the same components, although a detailed description of each such component may not be provided below with respect to each Figure.

### DETAILED DESCRIPTION OF THE PREFERRED EMBODIMENTS

In accordance with example aspects described herein are methods and apparatuses for reducing engine noise.

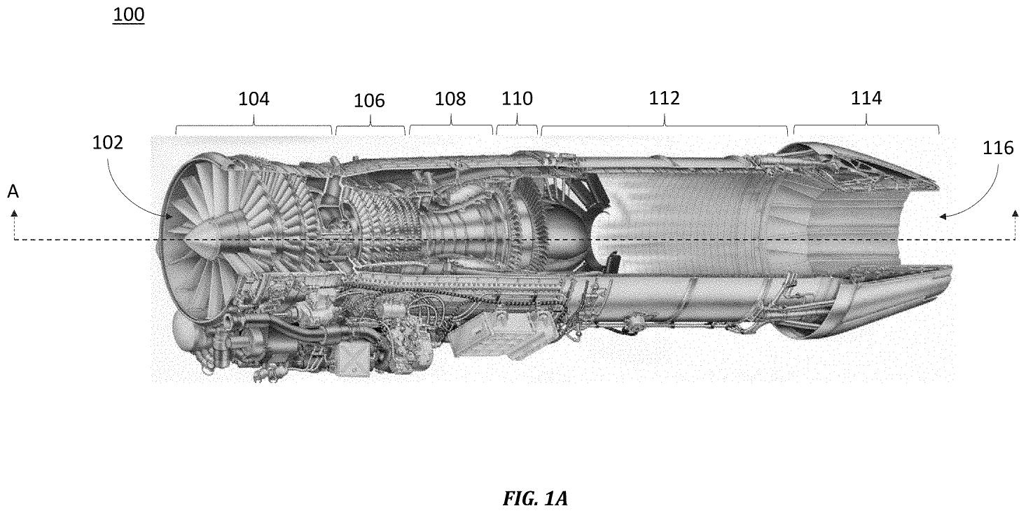

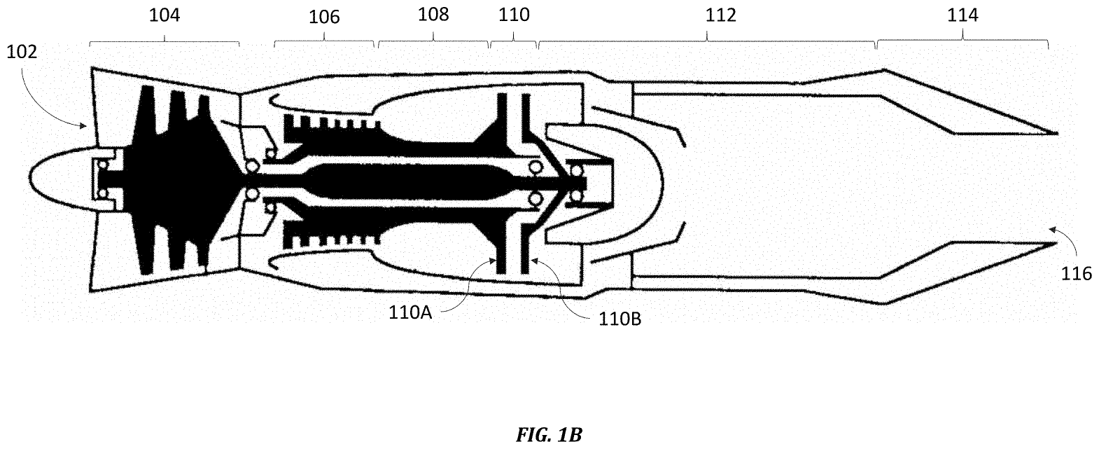

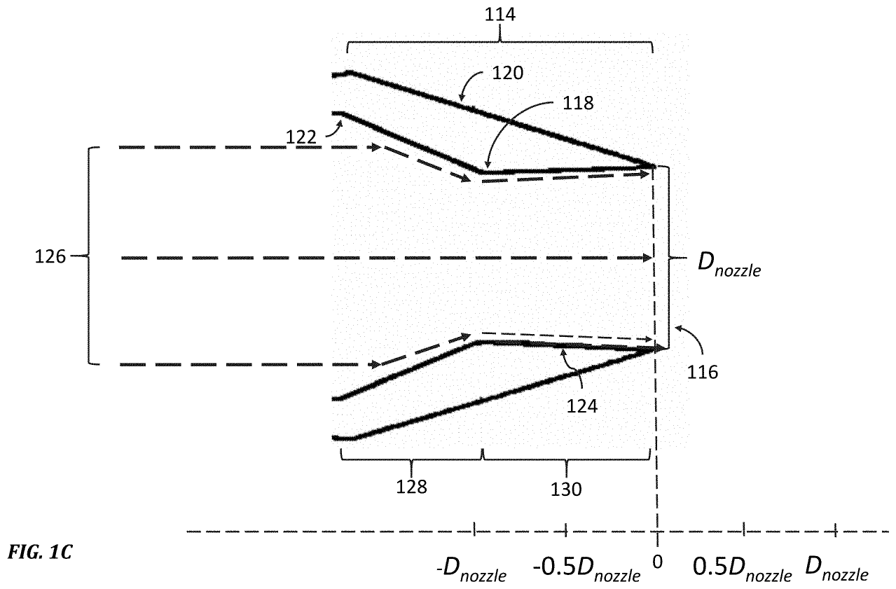

FIG. 1A is a perspective exploded view of a typical turbofan jet engine 100 that includes an afterburner and is designed for supersonic flight.

FIG. 1B is a cross-sectional view of engine 100 taken along an axis “A” defined by the low-pressure module's 110B turbine shaft. While a turbofan jet engine is shown in FIGS. 1A and 1B, the invention is not limited to this particular type of engine. The vortex generators described below may be applied to the nozzle sections of both subsonic and supersonic engines, and also to different types of jet engines (e.g., a turbojet engine).

As illustrated in FIGS. 1A and 1B, engine 100 may be divided into six modules: a fan inlet module 104, a compressor module 106, a combustor module 108, a turbine section 110 comprising a high-pressure turbine module 110A and a low-pressure turbine module 110B, an afterburner module 112, and a nozzle section 114. In brief, the operation of engine 100 will be explained. Air is drawn into the fan inlet module 104 through an air inlet 102. The air then enters the high-pressure turbine module 106 where the air is compressed. The compressed air is then provided to a combustor module 106 where the air mixes with fuel and combustion occurs. The high-pressure partially combusted air enters a turbine section 110 where it drives the high-pressure turbine module 110A which in turn drives the compressor module 106. The low pressure turbine module 110B located downstream of the high-pressure turbine module 110A is also driven by the partially combusted air. The low pressure turbine module 110B is connected to the fan inlet module 104 such that the fan inlet module 104 is driven when the low pressure turbine module 110B is driven. After passing through the turbine section 110, the partially combusted air enters the afterburner module 112. In the afterburner module 112, additional fuel is supplied and further combustion occurs which adds to the thrust produced by engine 100. Finally, the combustion products exit engine 100 through the nozzle section 114 which includes the nozzle exit 116.

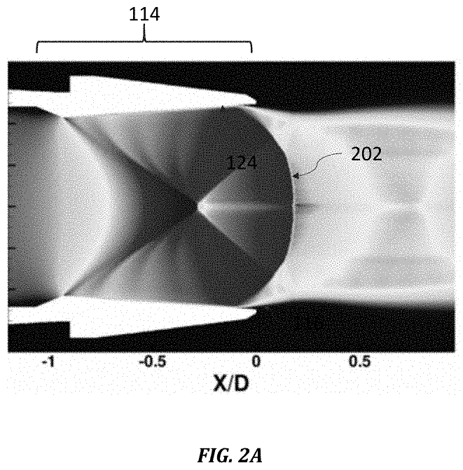

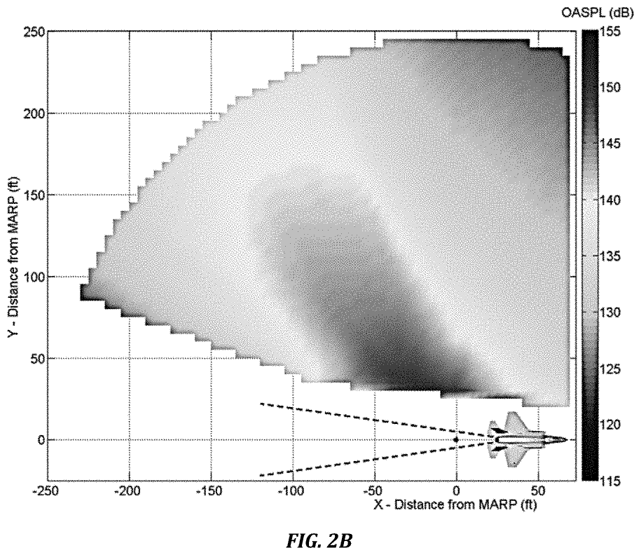

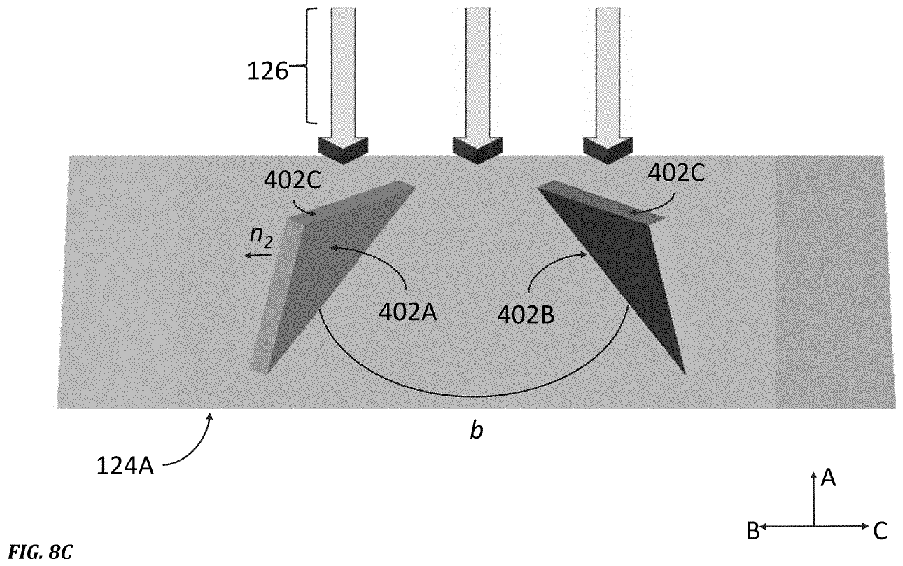

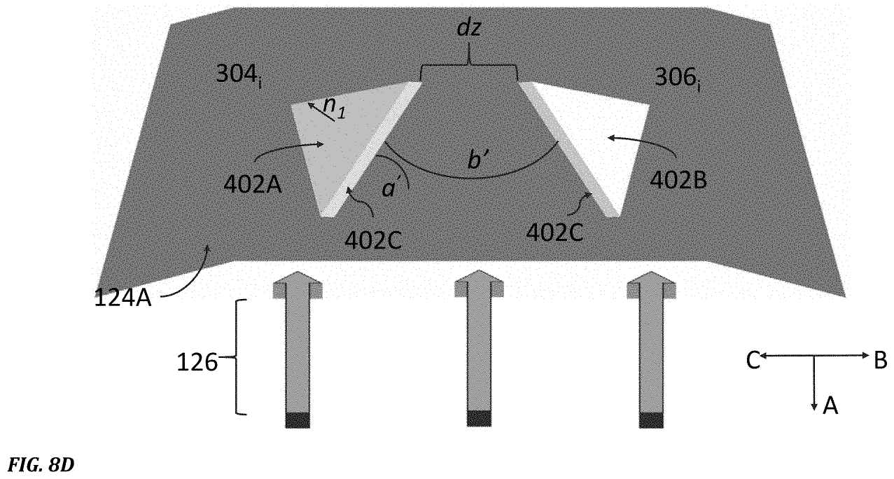

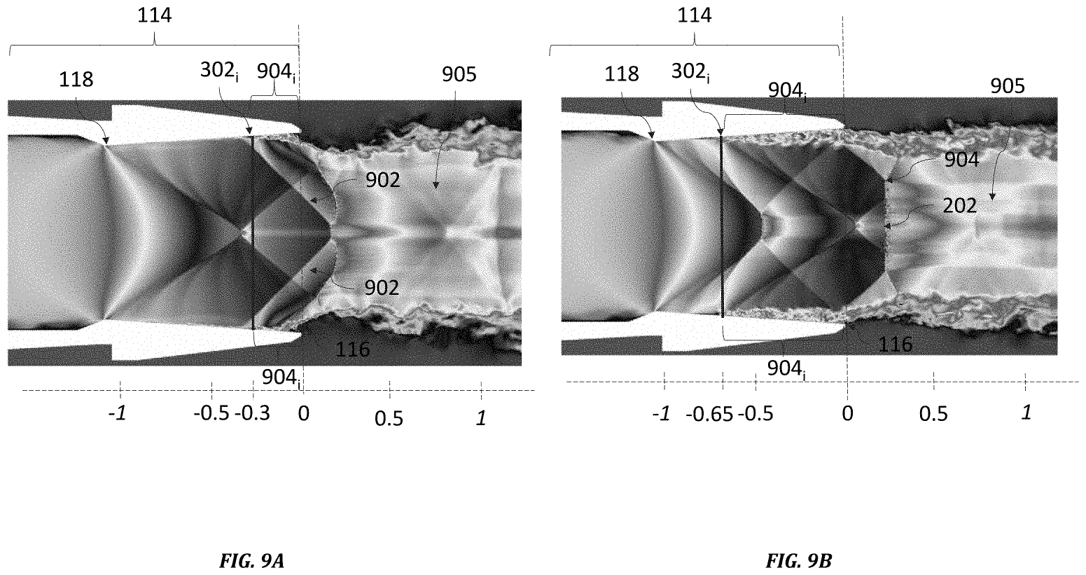

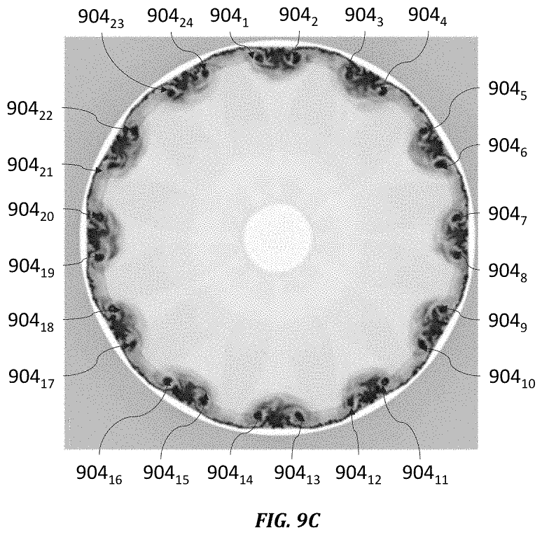

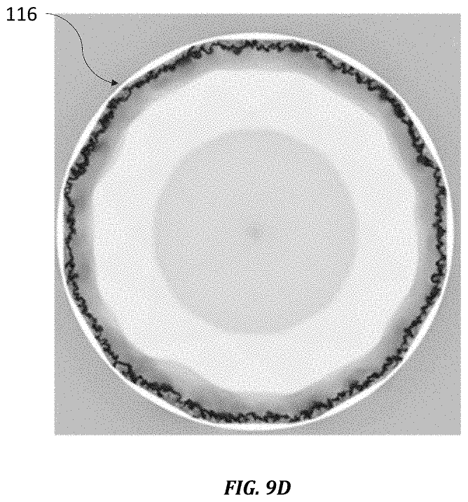

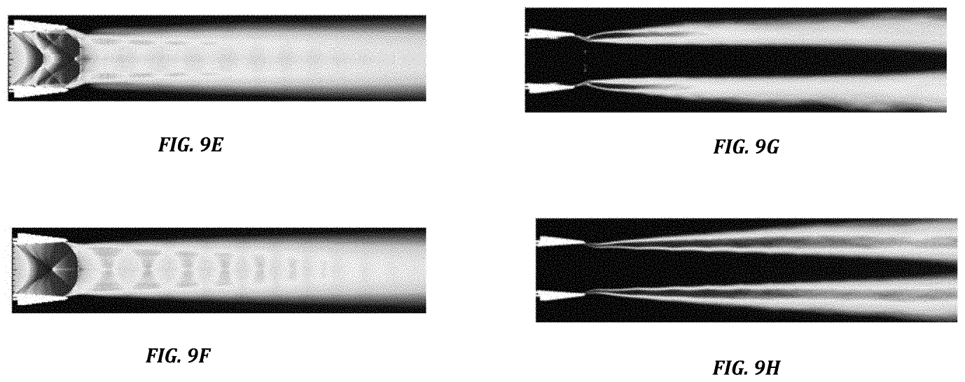

A supersonic aircraft is generally a convergent-divergent design, as illustrated in FIG. 1C, which is a cross-sectional view of the nozzle section 114 in FIG. 1B. Flow 126 from the afterburner module 112 enters a convergent portion 128 of the nozzle section 114 where a cross-sectional diameter of the nozzle section 114 in a direction perpendicular to axis A, or generally perpendicular the flow direction, decreases in the flow direction. As a result of this design, when the subsonic flow 126 impinges on an inner surface 122 of the nozzle section 114 in the convergent portion 128, flow velocity increases and the flow 126 is forced to converge to a minimum cross-sectional area, called the throat 118. The Mach number at this location is normally sonic if the nozzle pressure ratio is sufficiently high to ensure a supersonic jet exhaust. Flow 126 then enters a divergent portion 130 of the nozzle section 114, defined as the area between the throat 118 and the nozzle exit 116. In the divergent portion 130 of the nozzle section 114, the flow 126 expands as it travels to the nozzle exit 116 and the velocity is further increased and the Mach number reaches the designed value. In an overexpanded condition, the pressure inside the nozzle near the nozzle exit 116 is lower than the ambient pressure. The jet plume tends to converge to the jet centerline and nozzle boundary layer separation can occur near the nozzle exit 116 if the nozzle pressure is substantially lower than the ambient pressure. Shock waves are produced downstream of the throat 118 and travel into the jet plume, as illustrated in FIGS. 2A and 9E and 9F. The flow will eventually become subsonic further downstream.

FIG. 2A is a cross-sectional view of a nozzle section 114 showing time-averaged Mach numbers for flow 126 during a takeoff condition. As shown in FIG. 2A, a normal shock boundary 202 exists where the flow transitions from supersonic to subsonic velocities immediately downstream of the normal shock boundary 202. In a highly overexpanded condition, the radial size of the boundary 202 is not small. The radial size of this normal shock boundary 202 will decrease as the jet becomes less overexpanded, for example, during climbing or cruise.

The jet engine noise during typical full (non-afterburning) thrust is a maximum behind and to the side of the aircraft, as illustrated in FIG. 2B. FIG. 2B is a plan view showing noise levels to the port side aft of an aircraft just before takeoff. As shown in FIG. 2B, the noise level can exceed 135 dB at a distance of 200 feet. This puts ground personnel at risk for hearing damage. Having described the basic function of engine 100 and the noise that occurs at takeoff, attention will now be directed to micro vortex generators that may be disposed within a nozzle section 114 to reduce engine noise.

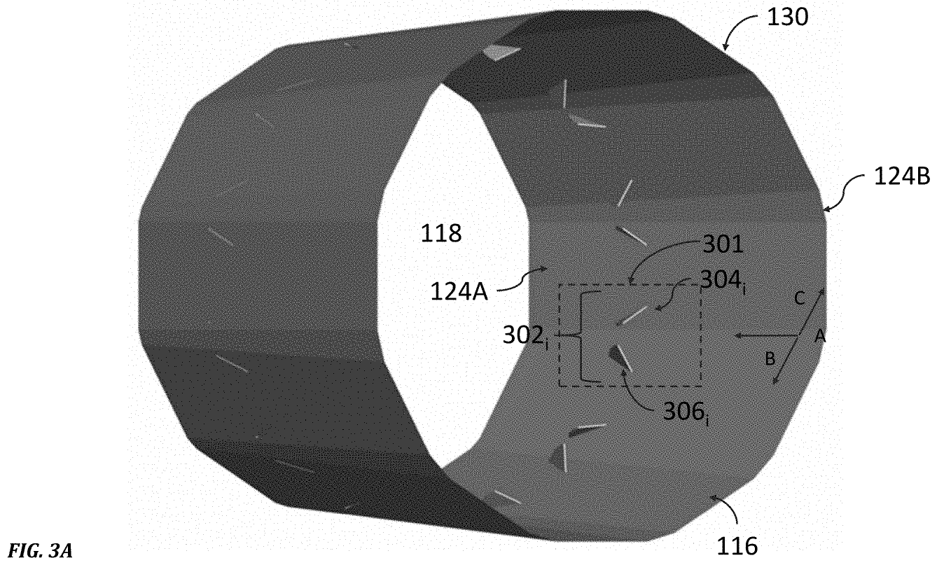

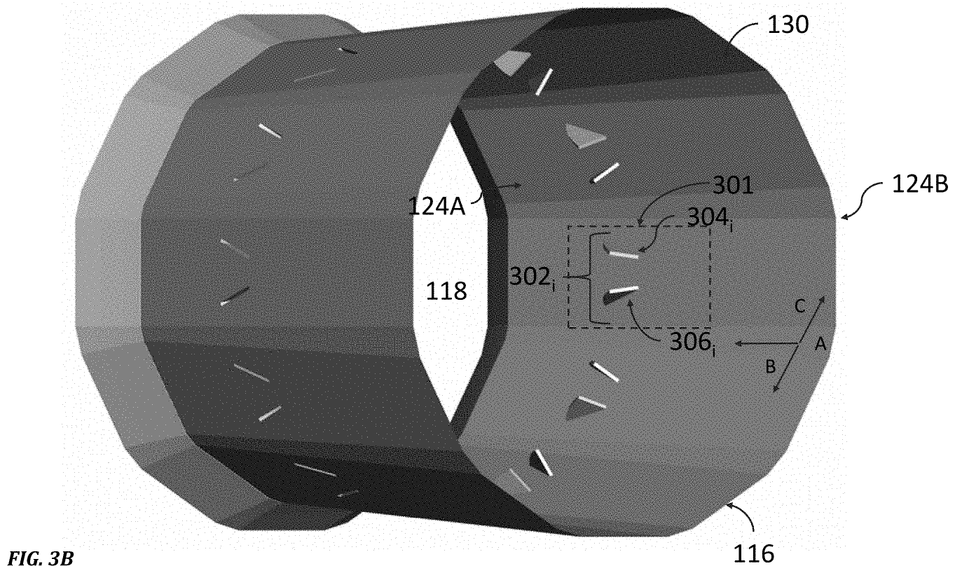

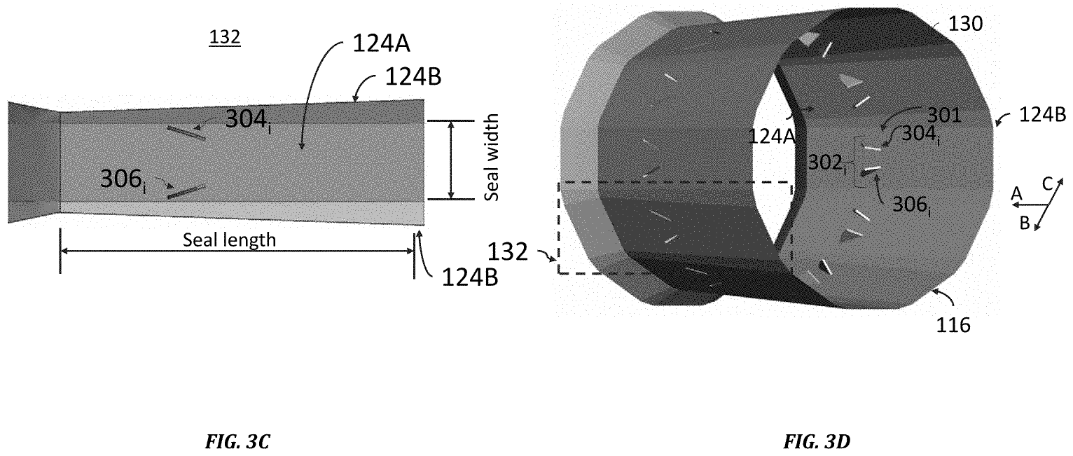

FIGS. 3A and 3B are perspective views of a divergent portion 130 of a nozzle section 114, according to two embodiments. In the embodiment shown in FIG. 3A, the divergent portion 130 of the nozzle section 114 is a faceted nozzle that comprises a plurality of seals 124A and flaps 124B between two neighboring seal surfaces 124A. As one of ordinary skill will appreciate, the seals 124A and the flaps 124B are typically not connected but rather most often lay in loose contact with each other. Of course, as one of ordinary skill will recognize, nozzle section 140 may also be implemented as a smooth rounded fixed nozzle. A faceted nozzle design, such as the one shown in FIG. 3A, is preferable to a smooth rounded fixed nozzle design because it allows the nozzle exit 116 to have a mechanism to vary its cross-sectional area to achieve peak performance at different engine settings and altitude/ambient conditions.

While the components and dimensions of the exemplary embodiments have absolute values, or a range of absolute values, once the nozzle section 140 is assembled, the sizes of components and distances within the nozzle section 140 may also be expressed as an integer or fraction of another parameter. For example, in one embodiment, the diameter of the nozzle exit 116 during takeoff is used herein to determine the sizes and distances of various items. However, since the diameter of the nozzle exit 116 may vary in the case of a faceted nozzle that includes a plurality of seals 124A and flaps 124B, the sizes of various features and distances may also be expressed as a fraction or multiple of the seal length and/or seal width, as explained below in reference to FIGS. 3C and 3D. As discussed above, in one embodiment the nozzle section 114 includes a plurality of seals 124A and a plurality of flaps 124B that are moveable relative to one another such that the nozzle diameter can vary. While the nozzle diameter 116 may vary, the dimensions of the seals 124A typically do not. As such, it may be preferable to use a length of a seal 124A (hereinafter referred to as the “seal length”) or a width of a seal 124B (hereinafter referred to as the “seal width”) as a value to reference all other values off of. FIG. 3C is a dimensional illustration of section 132 in FIG. 3D and shows the seal length and the seal width. FIG. 1C shows how the nozzle diameter 116 may also be used as a reference for sizes and dimensions of other components. Let's assume that the nozzle diameter as a specific point in time, or at a particular stage of flight, is known and thus fixed. FIG. 1C illustrates a cross-sectional plane (substantially perpendicular to axis A) and defined by the nozzle exit 116 represents the zero position on the axis of abscissas. Moving in a direction towards the throat 118, the distance may be expressed as a function the known nozzle diameter. Thus, in the embodiment shown in FIG. 1C, the throat 118 lies approximately −D_{nozzle} from the nozzle exit 116, where D_{nozzle} represents the equivalent diameter of the nozzle exit 116. As discussed above, if the diameter of the nozzle exit 116 is variable under different conditions (e.g., takeoff versus cruise conditions), then the diameter during one of those conditions may be used as D_{nozzle}. Having described how the seal length, seal width, or nozzle diameter 116 may be used as a reference for dimensions within the nozzle section 114, attention will now be directed to the micro vortex generators 302ᵢ.

In the embodiment shown in FIG. 3A, a pair of micro vortex generators 302ᵢ straddle a flap 124B. In other words, while each micro vortex generator 304ᵢ and 306ᵢ comprising a pair 302ᵢ is disposed on a seal surface 124A, there a flap 124B between them. In the embodiment shown in FIG. 3B, the two micro vortex generators 304ᵢ and 306ᵢ comprising a pair 302ᵢ are disposed on the same seal surface 124A. While pairs of micro vortex generators 304ᵢ and 306ᵢ are preferably used, one may also dispose a single micro vortex generator on one or more seal surfaces 124A. In the embodiments shown in FIGS. 3A and 3B, twelve pairs of micro vortex generators 302ᵢ are disposed within the nozzle section 114 and all are approximately equally distant from the nozzle exit 116. The distance from the nozzle exit 116 to the pairs of micro vortex generators 302ᵢ may be expressed as a function of the diameter of the nozzle exit 116, the seal length, or the seal width. This is illustrated in FIG. 1C

In the embodiments shown in FIGS. 3A and 3B, the distance from a portion of the micro vortex generators 304ᵢ and 306ᵢ proximate to throat 118 to the nozzle exit 116 is approximately 0.65D_{nozzle} or approximately 70% of the seal length (where D_{nozzle} at takeoff is approximately 1.085 of the seal length). This manner of representing dimensions as multiples of or a fraction of the diameter of the nozzle exit 116 or the seal length will be repeated below with respect to the discussion of the micro vortex generators 304ᵢ and 306ᵢ themselves. While 12 pairs of micro vortex generators 302ᵢ are illustrated in FIGS. 3A and 3B, this is only exemplary. In a preferred embodiment, the number of pairs of micro vortex generators 302ᵢ will correspond to the number of seal surfaces 124A in the faceted nozzle section 114. But in an alternative embodiment, the pairs of micro-vortex generators 302ᵢ are disposed on only some of the seal surfaces 124A. It should be noted that in FIG. 3B, the trailing edges of generators 304ᵢ and 306ᵢ (in the downstream direction) point towards each other, and thus a vortex generated by 304ᵢ and a vortex generated by 306ᵢ move closer towards each other as the vortices move downstream. Conversely, in an embodiment where the trailing edges of generators 304ᵢ and 306ᵢ point away from each other their respective vortices drift away from each other as they move downstream.

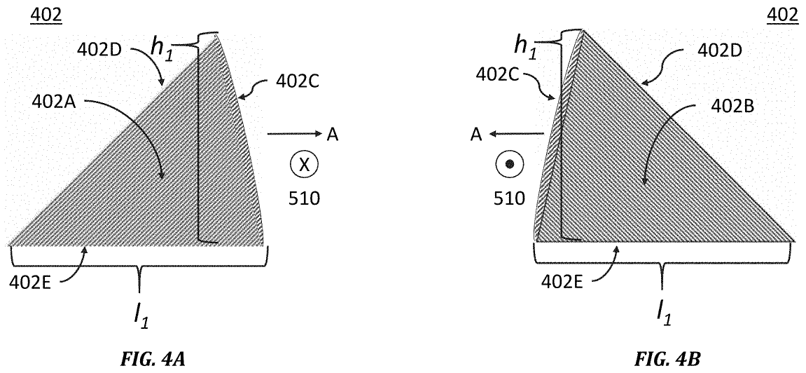

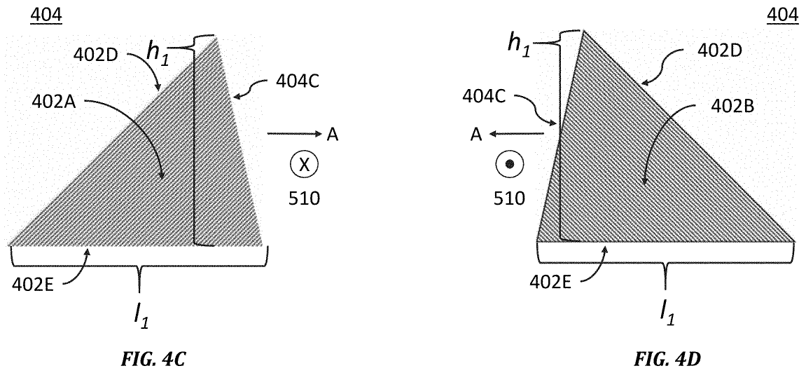

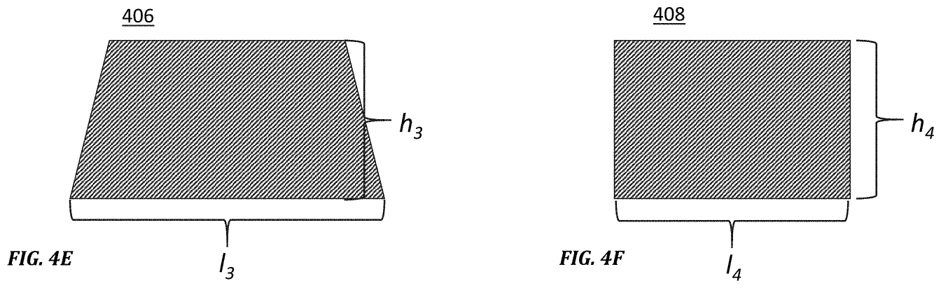

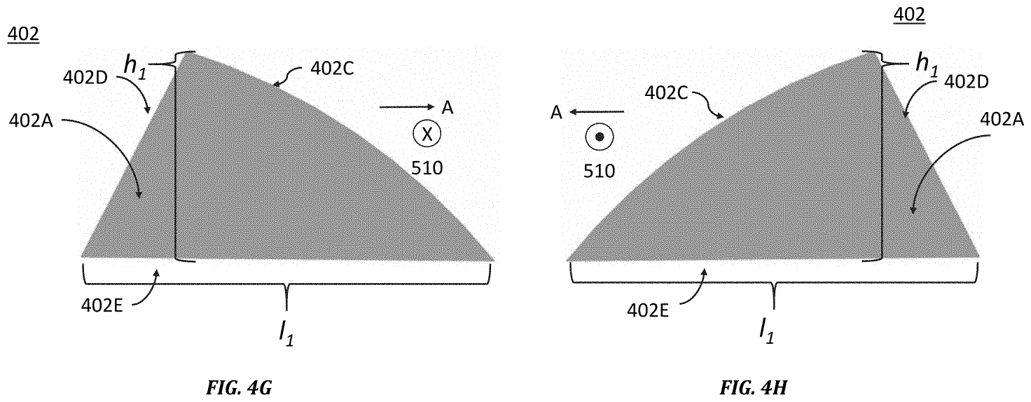

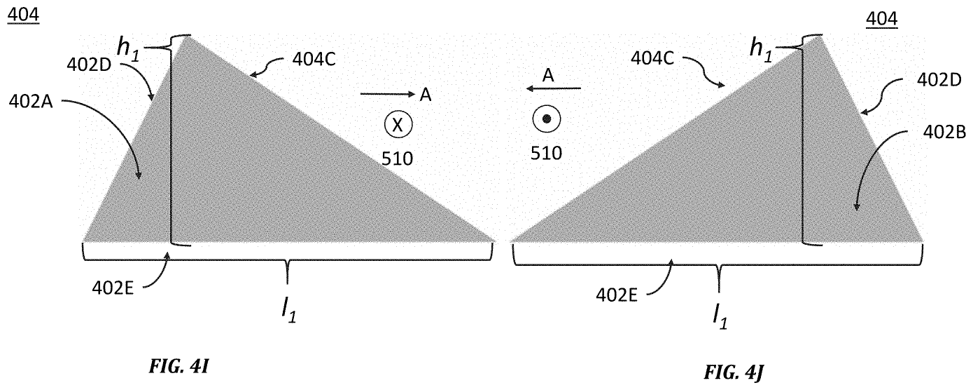

Having generally described the micro vortex generators 304ᵢ and 306ᵢ in relationship to nozzle section 114, attention will now be directed to the vortex generators 304ᵢ and 306ᵢ, with reference to FIGS. 4A-H. FIGS. 4A and 4B are side views of an exemplary micro-vortex generator 402. For reference, arrow A is provided to denote a direction extending from the nozzle exit 116 towards the throat 118 (opposite to the airflow direction), arrow 510 indicates a direction into the plane of the figure that corresponds to the direction indicated by arrow B in FIGS. 3A and 3B. In FIG. 4B, arrow 510 extends out of the plane of the page, indicating that the viewer is seeing the opposite side of micro-vortex generator 402 from the view in FIG. 4A. Micro-vortex generator 402 may be used as vortex generators 304ᵢ and 306ᵢ. In the embodiment shown in FIGS. 4A and 4B, the micro-vortex generator is a scalene triangle where one leg is curved. In FIGS. 4A and 4B, that leg is leg 402C. However, this is merely exemplary. In another embodiment, another leg, for example 402D, may be curved as well resulting in curved legs for legs 402C and 402D. Or, alternatively, legs 402C could be straight and only leg 402D curved. Still further, all legs could be straight, as shown in FIGS. 4C-D. The radius of curvature may be varied to increase or decrease the amount of blade surface exposed to the flow. In one embodiment, the micro-vortex generator 402 is generally flat such that surfaces 402A and 402B lie within respective planes that are generally parallel to each, at least to the degree of manufacturing machine tolerances and human precision with respect to installation. In an alternative embodiment, however, the micro-vortex generator 402 may have a larger width near its base (i.e., near leg 402E) than at its apex. In yet another alternative embodiment, micro-vortex generator 402 is twisted such that surfaces 402A and 402B do not lie in flat planes. In still a further embodiment, surfaces 402A and 402B are convex.

The micro-vortex generator 402 includes three legs: a base leg 402E which is serves as a surface of attachment to the nozzle seal surface 124A, a primary leg 402C, and a secondary leg 402D. The primary leg 402C may be shorter or longer than the secondary leg 402D (as illustrated in FIGS. 4G-4J). However, in one embodiment, the length of the primary leg 402C and the secondary leg 402D are equal. In the embodiment shown in FIGS. 4A-4D, the primary leg 402C is either curved or straight, and is disposed upstream regarding the direction of flow 126. Thus the secondary leg 402D is closer to the nozzle exit 126 than the primary leg 402C. The length of the base leg 402E is given by h and the height of the vortex generator is given by h₁. The height is defined as a distance measured from a point on the base leg 402E to a point where the primary leg 402C and the secondary leg 402D intersect, at an angle of 90° to the base leg 402E, as illustrated in FIGS. 4A and 4B. As discussed above, these distances may be expressed as multiples or fractions of the diameter of the nozzle exit 116.

FIGS. 4C and 4D are side views of another exemplary micro-vortex generator 404. FIGS. 4C and 4D are substantially similar to FIGS. 4A and 4B, respectively, and thus a description of elements shown in FIGS. 4A and 4B and described above is omitted for brevity. The primary difference between the embodiment shown in FIGS. 4A and 4B and the embodiment shown in FIGS. 4C and 4D is that the primary leg 404C in FIGS. 4C and 4D is not curved but straight. While the micro vortex generators in FIGS. 4A-4D are depicted as generally triangular, the invention is not limited thereto. As illustrated in FIGS. 4E and 4F, the micro vortex generators may also have a trapezoidal, rectangular shape or even other types of shapes. Moreover, as discussed above, the amount of curvature can be varied, as shown in FIGS. 4G and 4H, and the lengths of the legs varied such that leg 404C is longer than legs 402D, as illustrated in FIGS. 4I and 4J. Having described exemplary shapes and configurations for micro vortex generators 304ᵢ and 306ᵢ, attention will now directed to preferred materials for the same and methods of attaching generators 304ᵢ and 306ᵢ.

As one of ordinary skill will appreciate, the environment inside of nozzle section 114 is extremely harsh. Flow 126 is extremely hot and moving a high velocity. It is not uncommon for temperatures within a nozzle section 114 to reach 3,000 degrees F. in operation. As discussed below, the micro vortex generators 304ᵢ and 306ᵢ cause a portion of flow 126 impinging thereupon to turn which results in vortices downstream of the micro vortex generators 304ᵢ and 306ᵢ. The generation of these vortices leads to the reduction in noise, as explained below. The micro vortex generators 304ᵢ and 306ᵢ may be formed of any material that is physically suitable for the harsh environment inside of nozzle section 114. If the nozzle section 114 is principally formed of metal or a metal alloy, then thermal expansion may limit the ability to use dissimilar metals. More specifically, if the metals or metal alloys expand at different rates over the same temperature range, then expansion and contraction of the dissimilar metals may cause a failure at a point where the dissimilar metals meet. Thus, in an embodiment where metals and metal alloys are used for the nozzle section, the same metal or metal alloy or a metal or metal alloy with substantially similar thermal expansion behavior are preferably used. In that embodiment, the micro vortex generators 304ᵢ and 306ᵢ may be welded to seals 124A and/or flaps 124B depending upon the arrangement of generators 304ᵢ and 306ᵢ. If generators 304ᵢ and 306ᵢ are welded, then a suitable heat treatment is necessary to prevent cracking, as one of ordinary skill in the art will recognize.

In another embodiment, where the nozzle section 114 is at least partially constructed from composite materials or ceramic composite materials, generators 304ᵢ and 306ᵢ are preferably included in the layup forms for the seals 124A and flaps 124B, thus making generators 304ᵢ and 306ᵢ an integral part of the seals 124A and flaps 124B.

In yet another embodiment, generators 304ᵢ and 306ᵢ are formed from reinforced carbon-carbon (RCC), which has been successfully used on the US Space Shuttle and is proven to perform well in harsh environments, like that of nozzle section 114. Generators 304ᵢ and 306ᵢ fabricated from RCC with a suitable base and metal threaded receiver on the underside of the seal 124A or flap 124B to which it is being attached, could then be attached with a bolt from underneath. In yet a still further embodiment, carbon fiber-reinforced silicon carbide (C/SiC) and chemical zirconia ceramics (CZC) could also be used and attached in the same manner as generators 304ᵢ and 306ᵢ formed from RCC.

As one of ordinary skill will appreciate, the methods of attaching generators 304ᵢ and 306ᵢ depend on the jet engine nozzle seal and flap materials. A preferred method of attachment should maintain the shape and angle of generators 304ᵢ and 306ᵢ for the life span of the nozzle section 114. As one of ordinary skill in the art will appreciate, the life span of the nozzle section 114 is determined by aircraft designers based upon the intended use of the aircraft and may range from a relatively short period (weeks) to an extended period (decades). Having described exemplary materials for generators 304ᵢ and 306ᵢ and methods of attaching the same to nozzle section 114, attention will now be directed to various embodiments employing different configurations of generators 304ᵢ and 306ᵢ.

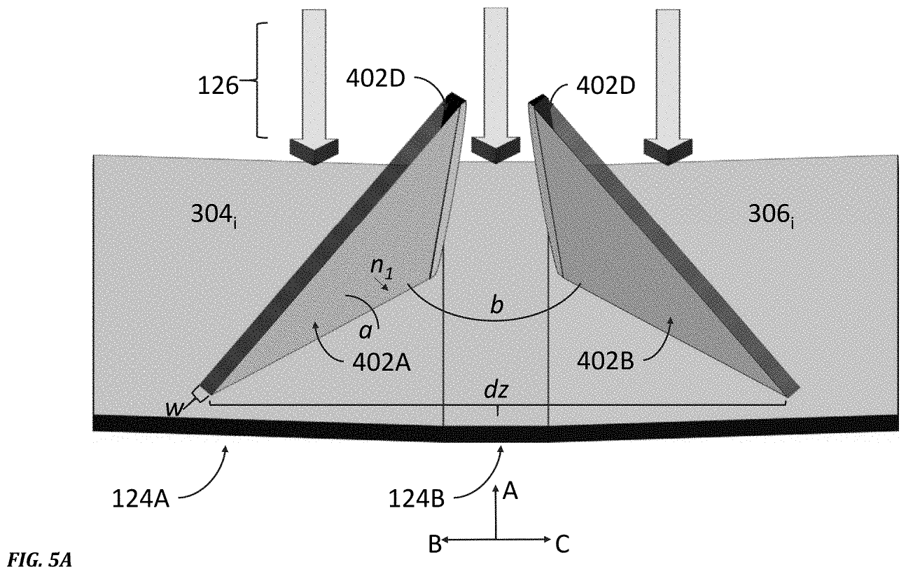

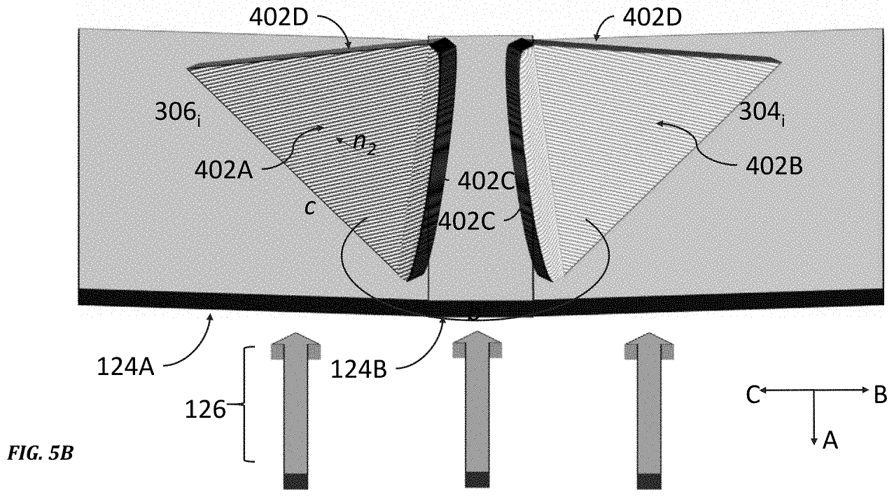

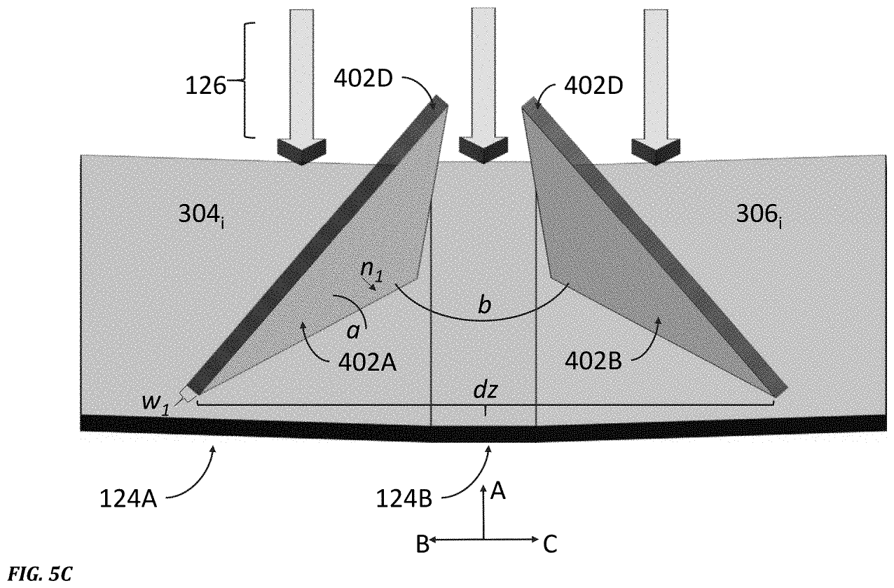

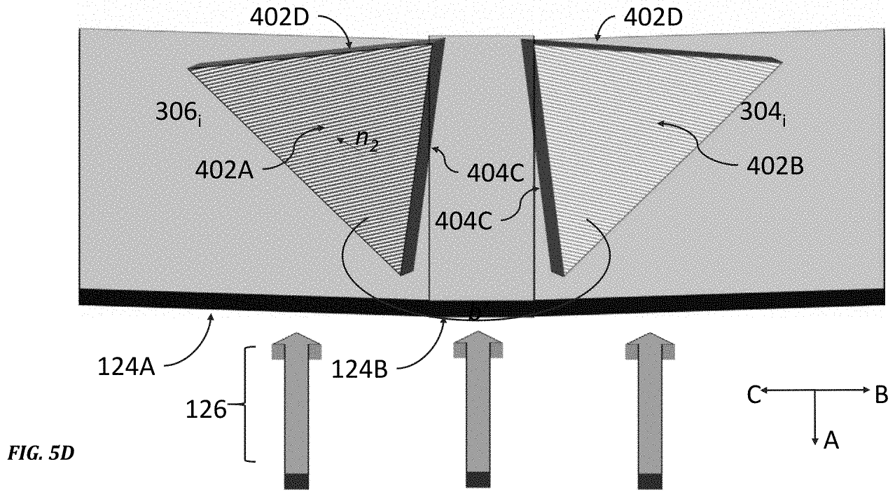

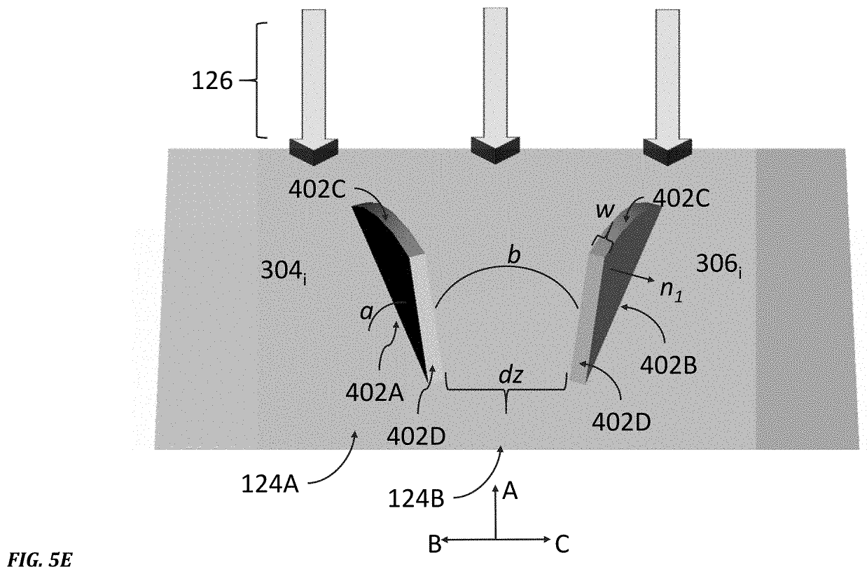

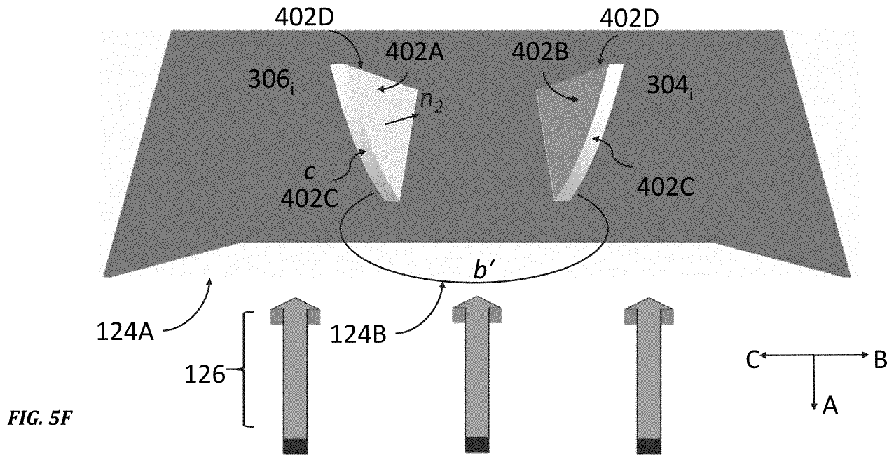

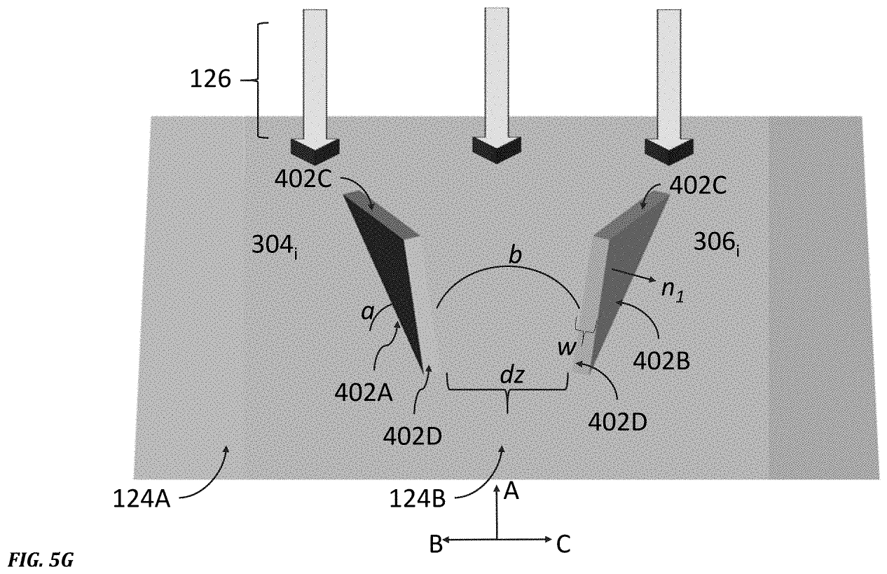

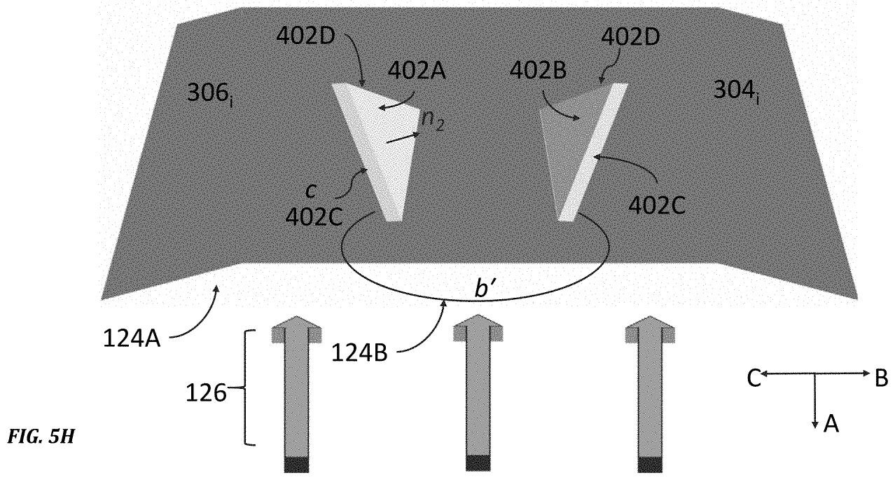

FIG. 5A is a perspective view of a portion of nozzle section 114 shown in box 301 in FIGS. 3A and 3B in the direction of throat 118. FIG. 5B is a perspective view of the same portion of nozzle section 114 depicted in FIG. 5A, but viewed from the opposite side, that is in the direction of nozzle exit 116. FIGS. 5A and 5B show two micro-vortex generators 304ᵢ and 306ᵢ. In this embodiment, the micro-vortex generators 304ᵢ and 306ᵢ are embodied as the triangular shaped micro-vortex generators 402 shown in FIGS. 4A and 4B with a curved primary leg 402C. In addition to the length of base leg 402E (l₁) and the height of the micro-vortex generator (h₁), four additional variables define the micro-vortex generators 304ᵢ and 306ᵢ: (i) the angle (a) between the seal surface 124A and surfaces 402A and 402B of vortex generators 304ᵢ and 306ᵢ, respectively, (ii) the distance (dz) between the trailing edges of the vortex generators 304ᵢ and 306ᵢ—that is the portions of generators 304ᵢ and 306ᵢ that is closest to nozzle exit 116, (iii) the angle (b) between surfaces 402A and 402B of vortex generators 304ᵢ and 306ᵢ, and the thickness or width (w₁) of the secondary leg 402D, which may be between 3% and 5% of the seal width, inclusive, or 0.006 D_{nozzle} and 0.01 D_{nozzle}, inclusive, in a preferred embodiment. For completeness, an angle b′ is also shown. As shown in FIGS. 5A and 5B, the primary leg 402C is curved and disposed in an upstream position relative to flow 126 such that it is proximate to throat 118.

FIGS. 5C and 5D are substantially the same as FIGS. 5A and 5B, except that the micro-vortex generators 304ᵢ and 306ᵢ are embodied by vortex generators 404 instead of 402. As discussed above, the primary difference between vortex generators 402 and 404 is that generator 402 includes a curved surface for the primary leg 402C whereas generator 404 does not, as illustrated in FIGS. 5C and 5D. FIGS. 5E-5F show micro-vortex generators 304ᵢ and 306ᵢ with lengths and orientations different from those in FIGS. 5A-D, and corresponding to FIGS. 4G and 4H. FIGS. 5G and 5H show micro-vortex generators 304ᵢ and 306ᵢ that employ straight legs instead of curved legs, corresponding to FIGS. 4I and 4J.

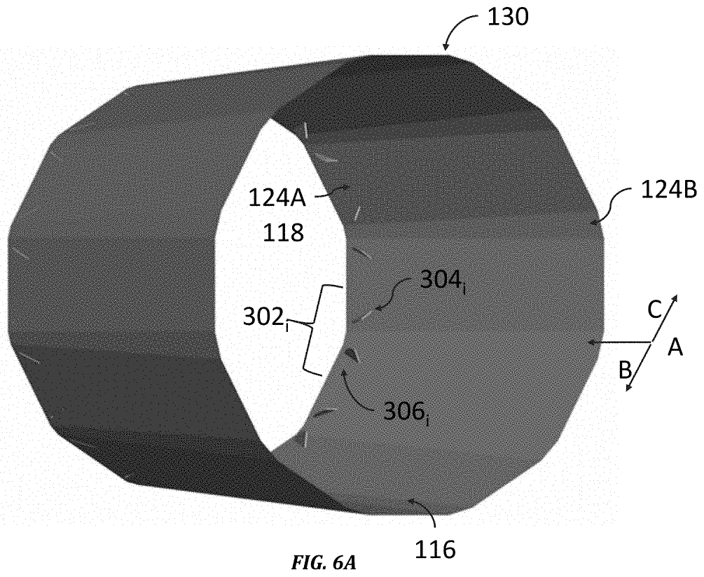

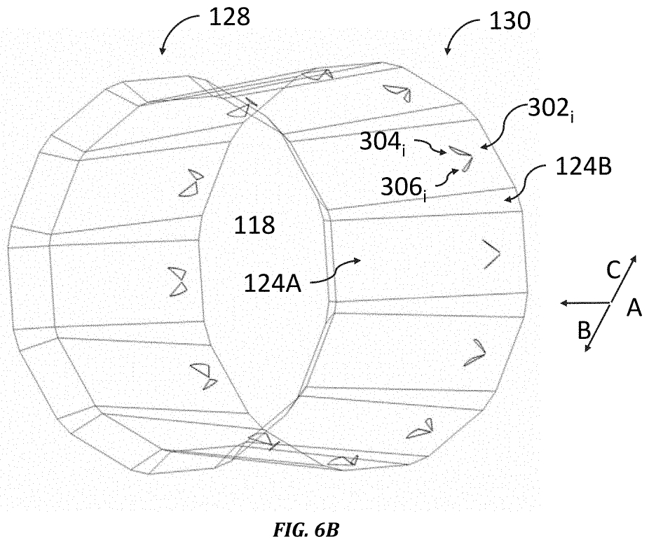

In the embodiments shown in FIGS. 3A and 3B and FIGS. 5A-5H, the variables defining the size and orientation of the micro-vortex generators 304ᵢ and 306ᵢ, namely l₁, h₁, w₁, dz, a, and b are the same for each pair of vortex generators 302ᵢ. Of course, as one of ordinary skill will appreciate each of these values could be different for each pair of vortex generators 302ᵢ, or the values l₁, h₁, and w₁ may differ for each of generators 304ᵢ and 306ᵢ of a generator pair 302ᵢ. Moreover, in FIGS. 5A-5D, the vortex generators 304ᵢ and 306ᵢ are oriented such that the primary legs 402C and 404C are upstream and proximate to the throat 118. However, that configuration is merely exemplary. As one of ordinary skill will appreciate, the variables l₁, h₁, w₁, dz, a, and b may be varied to produce differed sized micro-vortex generators 304ᵢ and 306ᵢ with different orientations. FIGS. 6A-7B and 8A-B are illustrative.

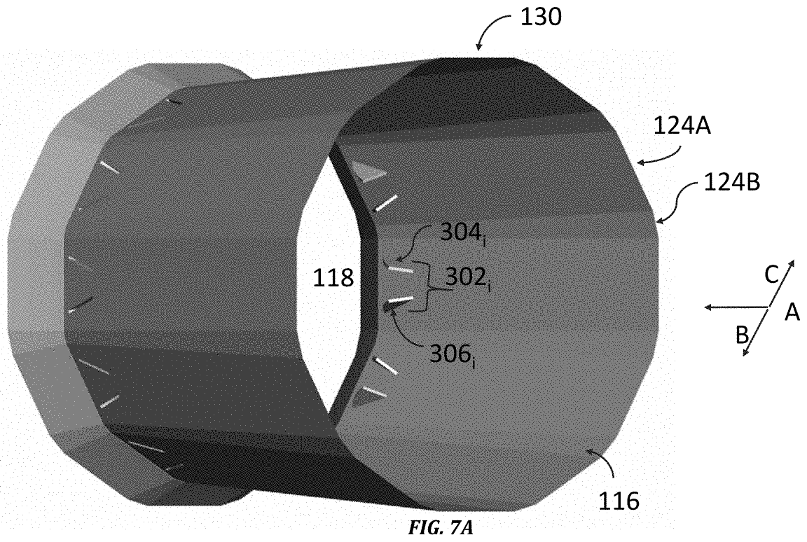

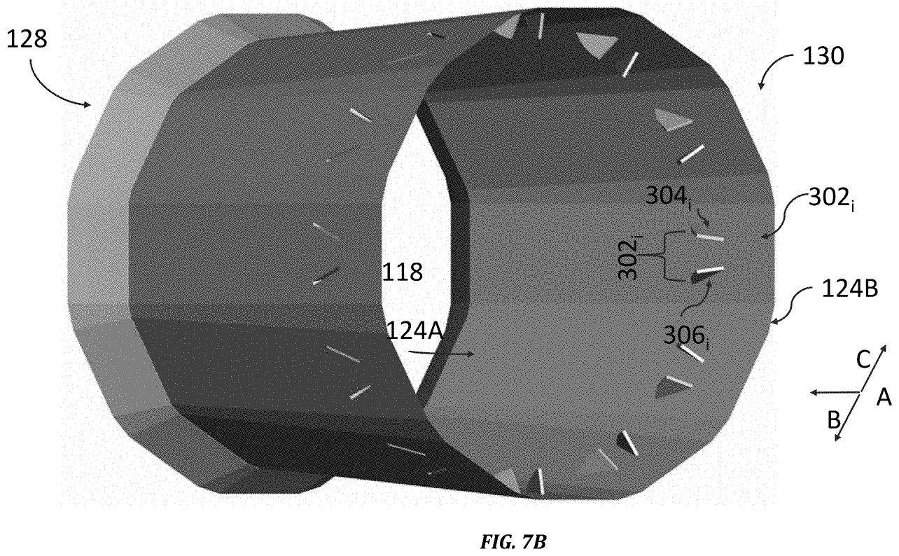

FIGS. 6A-7B are perspective views show different locations and configurations of the generators 302ᵢ according to exemplary embodiments. FIG. 6A is a perspective view of a divergent portion 130 of nozzle section 114 according to another embodiment. FIG. 6A is substantially the same as FIG. 3A, except that the plurality of micro-vortex generators 302ᵢ are disposed adjacent to the throat 118 in the axial direction. FIG. 6B is a perspective view of a divergent portion 130 of nozzle section 114 according to yet another embodiment. Like FIG. 3A, a plurality of seal surfaces 124A and flaps 124B are provided. Also like FIG. 3B, twelve pairs of micro-vortex generators 302ᵢ are provided and disposed on seal surfaces 124A. However the axial location is closer to the nozzle exit 116, but upstream of the boundary-layer separation point. Unlike FIG. 3A, in FIG. 6B the pairs of micro-vortex generators 302ᵢ are not arranged to straddle the flaps 124B, but rather both micro-vortex generators 304ᵢ and 306ᵢ are disposed on the same seal surface 124A. FIG. 7A is a perspective view of a divergent portion 130 of nozzle section 114, according to a further embodiment. In FIG. 7A, the pairs of micro-vortex generators 304ᵢ are disposed proximate to throat 118. FIG. 7B is a perspective view of a divergent portion 130 of nozzle section 114, according to a still further embodiment. In FIG. 7B, the pairs of micro-vortex generators 304ᵢ are disposed proximate to nozzle exit 116.

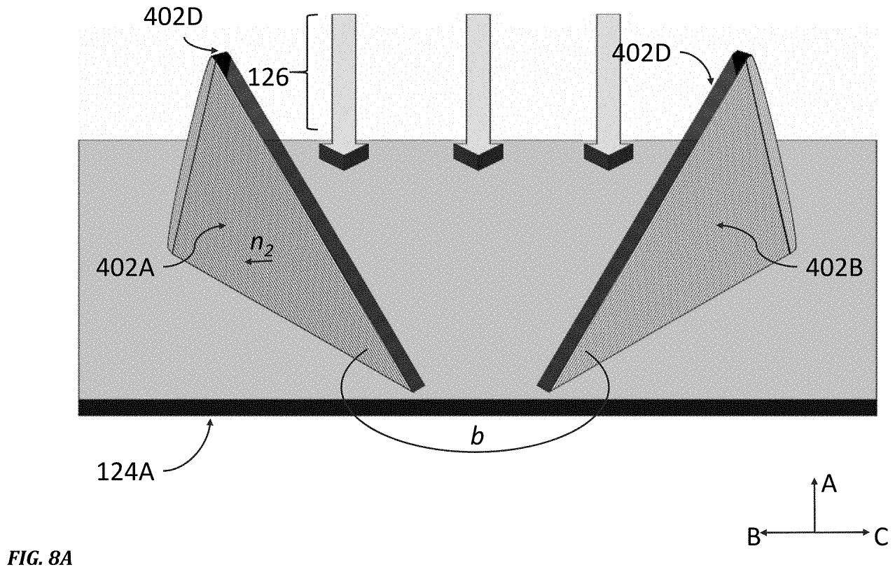

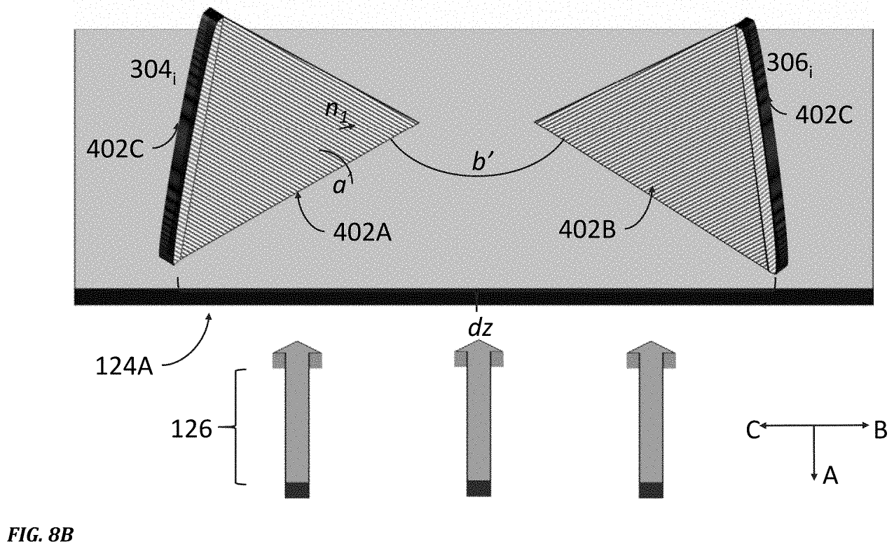

As shown in FIGS. 8A and 8B, the primary leg 402D is arranged in an upstream position as illustrated in FIGS. 3A and 5A-5D, but the angle b between face 402A of generator 304ᵢ and face 402B of generator 306, is much larger than that in FIGS. 5A-5D. Conversely, an angle b′ is less. The angle a is also different from what is shown in FIGS. 5A-5D. FIGS. 8C and 8D show a configuration where each of the legs is straight and generators 304ᵢ and 306ᵢ have different orientations from FIGS. 8A and 8B. Having described the arrangement and orientation of micro-vortex generators 304ᵢ and 306ᵢ within a nozzle section 114, attention will now be directed to the beneficial noise suppressing effects of the plurality of pairs of micro-vortex generators 302ᵢ.

FIGS. 9A and 9B are cross-sectional views of nozzle section 114 according to two exemplary embodiments. In FIG. 9A, 12 micro-vortex generator pairs 302ᵢ are respectively disposed on 12 seal surfaces 124A at a distance of −0.25D_{nozzle} or 27% of the seal length from the nozzle exit 116. In FIG. 9B, 12 micro-vortex generator pairs 302ᵢ are respectively disposed on 12 seal surfaces 124A at a distance of −0.65D_{nozzle} or 70% of the seal length from the nozzle exit 116. Of course, these distances are merely exemplary and, micro-vortex generators 302ᵢ can be placed at any location inside the nozzle, but preferably are within a range of −0.75D_{nozzle} to −0.3D_{nozzle}, or around 80% to 30% of the seal length. However, this range of location may vary with the structure of the divergent section where the vortex generators are implemented. The idea is to place those micro-vortex generator pairs 302ᵢ at the axial location that can effectively weaken the shock-cell structure. The reason the plurality of micro-vortex generator pairs 302ᵢ are not located near the nozzle exit 116, in a preferred embodiment, when a first plurality of micro-vortex generators 302ᵢ are provided, is because of the effects of boundary layer separation. As one of ordinary skill will appreciate, in FIG. 2A, a portion of the flow 126 very near to the nozzle surface 124 is subsonic. Higher-pressure ambient fluid can flow into nozzle section 114 through this subsonic boundary layer region, causing the nozzle boundary layer to separate near the nozzle exit. This can reduce the effectiveness of the plurality of micro-vortex generator pairs 302ᵢ if they are located near the nozzle exit 116.

Returning to FIGS. 9A and 9B, in both embodiments, the plurality of micro-vortex generator pairs 302ᵢ are arranged as shown in FIG. 3C with respect to the seal surfaces 124A, and oriented as shown in FIGS. 5A and 5B. The distances are measured from the nozzle exit 116 to a point on the plurality of pairs of micro-vortex generators 302ᵢ that is proximate to throat 118. Thus, a location on the abscissas corresponding to the nozzle exit 116 has a value of “0” whereas a location “−1” away from the nozzle exit 116 corresponds to the distance of a nozzle diameter towards the throat 118. When one compares FIG. 2A, which shows a nozzle section 114 that does not include a plurality of pairs of micro-vortex generators 302ᵢ, to FIGS. 9A and 9B it is immediately apparent that the presence of the micro-vortex generators 302ᵢ creates a plurality of vortices 904ᵢ that have a strong effect on shock cell structure within the nozzle section 114. This effect on the shock-cell structure is sensitive to the choice of the axial location. In FIG. 9A, oblique compression waves 902 are generated by vortex generators 302ᵢ and they strengthen the downstream shock 905 and this increases the shock-associated noise. But in FIG. 9B, a strong normal shock wave 202 is generated and the downstream shock cells are weakened. This results a reduction of the shock-associated noise. On the other hand, if the location is very near the throat 118, the effect on the shock-cell structure and the shock-associated noise is limited. In addition, the effect on the shock-cell structure also varies with the nozzle pressure ratio. For example, the location of 0.35 D_{nozzle} (approximately 38% of the seal length from the nozzle exit) can cause substantial shock-cell cancellation. Thus, the location between −0.7D_{nozzle} and −0.3 D_{nozzle} or between approximately 80% and 30% of the seal length from the nozzle exit 116 is preferred.

The plurality of vortices 904ᵢ are further illustrated in FIG. 9C. FIG. 9C is a cross-sectional view of the nozzle exit 116 in FIG. 9B, and shows the instantaneous Mach numbers at different points in flow 126. FIG. 9C shows 24 vortices 904₁ . . . 904₂₄ created by the twelve pairs of micro-vortex generators 302ᵢ. The micro-vortex generator pairs 302ᵢ interact with flow 126 creating oblique shocks that intersect at the center creating a Mach disk inside the nozzle section 114. The down washing region between the neighboring pairs of micro-vortex generator pairs 302ᵢ helps to stabilize the boundary layer, substantially delaying separation. This can be seen by comparing FIG. 9C and FIG. 9D, where no vortex generators are used. The flow shown in FIG. 9C is much less attached to the nozzle surface. In the embodiments shown in FIG. 9B, the shock fronts 902 and 904 are weakened resulting weaker shock cells in the downstream as can be seen by comparing the shock-cell structure in the jet plume, as illustrated in FIGS. 9E-9H. FIG. 9E illustrates time-averaged Mach number distributions for a jet plume that corresponds to a baseline nozzle (i.e., a nozzle section 114 without micro-vortex generators). FIG. 9F also illustrates time-averaged Mach number distributions for a jet plume emanating from a nozzle section 114 that includes a plurality of micro-vortex generator pairs 302ᵢ, as shown in FIG. 9B and described above. It is self-evident from comparing FIGS. 9E and 9F that a relatively weaker shock-cell structure is formed in the downstream jet plume of FIG. 9F, as compared to FIG. 9E. This weaker shock-cell structure generates much less shock-associated noise. The vortices 904, created by the micro-vortex generators 304ᵢ grow as they travel downstream enhancing the mixing of flow 126, as illustrated in FIG. 9B.

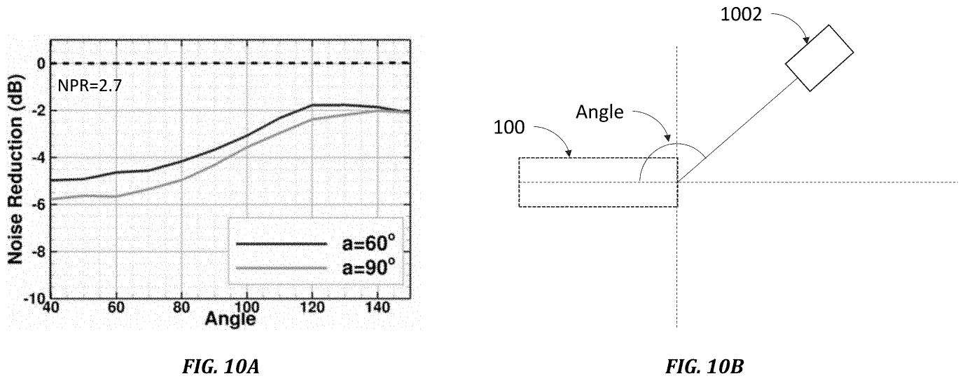

FIG. 9G and FIG. 9H are turbulent intensity distributions generated by the baseline nozzle and the embodiment shown in FIG. 3, respectively. The turbulent intensity downstream of nozzle exit 116 is greatly reduced by the vortices 904, mixing with flow 126 and this results a reduction of the mixing noise, especially the noise in the peak radiation direction. Having described the effect of the plurality of pair of micro-vortex generators 302ᵢ on flow 126 and shock cell structure and the downstream flow turbulence intensity, attention will now be directed to identifying preferred ranges of values for the principle variables: l₁, h₁, w₁, dz, a, and b that reduce the engine noise. The data shown in FIGS. 10A-13A was generated in an anechoic test chamber in which noise levels were recorded by a plurality of microphones placed at a distance of 12 feet from a nozzle exit 116 over a range of angles from 40-150 degrees. The micro-vortex generators 304ᵢ and 306ᵢ were embodied as scalene triangles with a curved primary leg 402C, as described above and illustrated in FIGS. 3, 5A, and 5B. In one embodiment, noise reduction is not sensitive to thicknesses ranging from 2.5% to 5% of the seal width and thus a system designer or engineer may set the width of generators 304ᵢ and 306ᵢ to be within this range without affecting the magnitude of noise reduction.

FIG. 10A illustrates the effect of varying angle a (the angle between a face 402A/402B and a seal surface 124) while values l₁, h₁, w₁, dz and b are held constant. FIG. 10B illustrates how noise is measured to produce the data shown in FIG. 10A. In FIG. 10B, a recording device 1002 is located at a certain distance from an engine 100 and at a certain angle relative to the centerline of engine 100. In practice, to achieve accurate measurements a plurality of recording devices 1002 are provided angles ranging from 40 to 150 degrees, but at a fixed distance from the centerline of engine 100 at the nozzle exit. Thus, angles that are less 90 degrees have a component in a direction towards the aircraft while angles that are greater than 90 have a component in a direction away from the aircraft. In the embodiment corresponding to FIG. 10A, the nozzle pressure ratio is 2.7, which corresponds to a nozzle pressure ratio during takeoff. FIG. 10A shows an overall reduction in noise at this nozzle pressure ratio when the angle a is 60 and 90 degrees. There is a modest decrease in noise reduction when a is 90 degrees as compared to 60 degrees; but overall noise reduction is not particularly sensitive to angle a. Thus, in a preferred embodiment, the angle a may vary between 45 degrees to 145 degrees.

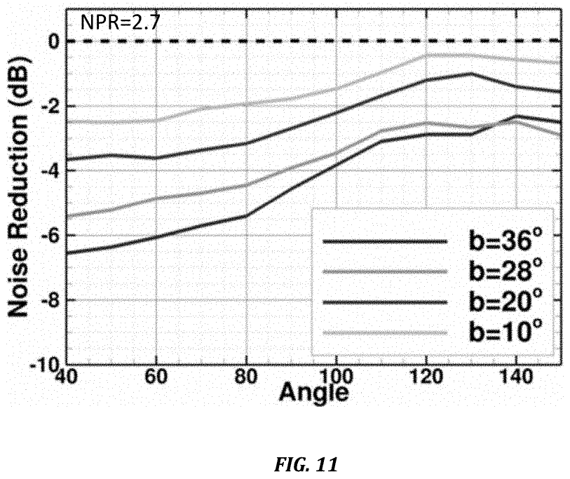

FIG. 11A illustrates the effect of varying angle b (the angle between faces 402A and 402B of a pair of micro-vortex generators 304ᵢ and 306ᵢ when the nozzle pressure ratio is 2.7. Angles of 28-36 degrees produce a greater amount of noise reduction that angles between 10-20 degrees. However, additional data collected from other experimental tests found that further increases in angle b do not result in a proportional increase in noise reduction with a height of 0.05D_{nozzle}, but does result in additional thrust loss. As one of ordinary skill will appreciate, however, the particular optimal angle depends on the blade height and the MVG orientation to the incoming flow. It is found that if the blade height is smaller, for example, 0.025D_{nozzle}, a larger angle up to 120 degrees can be used to increase noise reduction with an acceptable thrust loss. But such small blade height can only provide limited noise reduction benefit. If the orientation of generators 304ᵢ and 306ᵢ to the incoming flow is arranged as in FIG. 5A and generators 304ᵢ and 306ᵢ are disposed on alternating seals, an optimal angle may be greater than 36°. Thus, in a preferred embodiment, angle b is between 25-50 degrees but may be as broad as 10-120 degrees, inclusive.

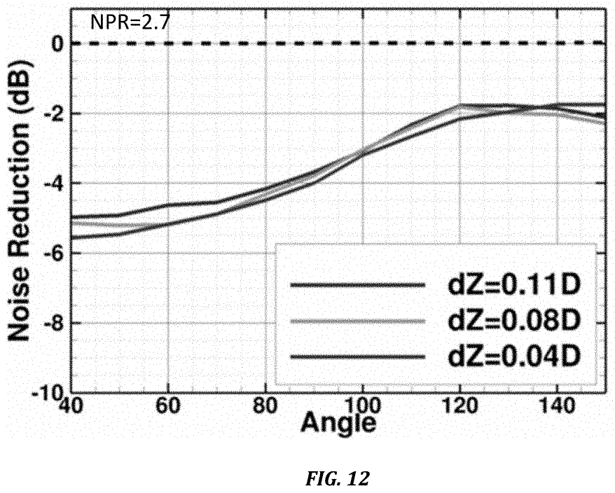

FIG. 12 illustrates the effect of varying the distance (dZ) between the trailing edge of the micro-vortex generators 304ᵢ and 306ᵢ. When this distance is small strong vortex coalescence may exist which will reduce the vortex strength further downstream and degrade noise reduction performance. But, if the distance is too large then the trailing edges may be too close to the seal edge and cause interference with other engine components. In a preferred embodiment, dZ is within the range of 0.04-0.11D_{nozzle}, inclusive, which corresponds to 0.2-0.6 of the seal width. As shown in FIG. 12, values within this range produce similar results.

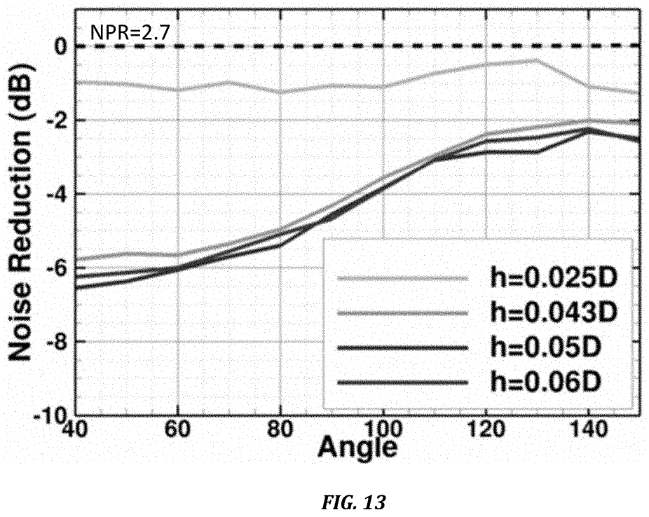

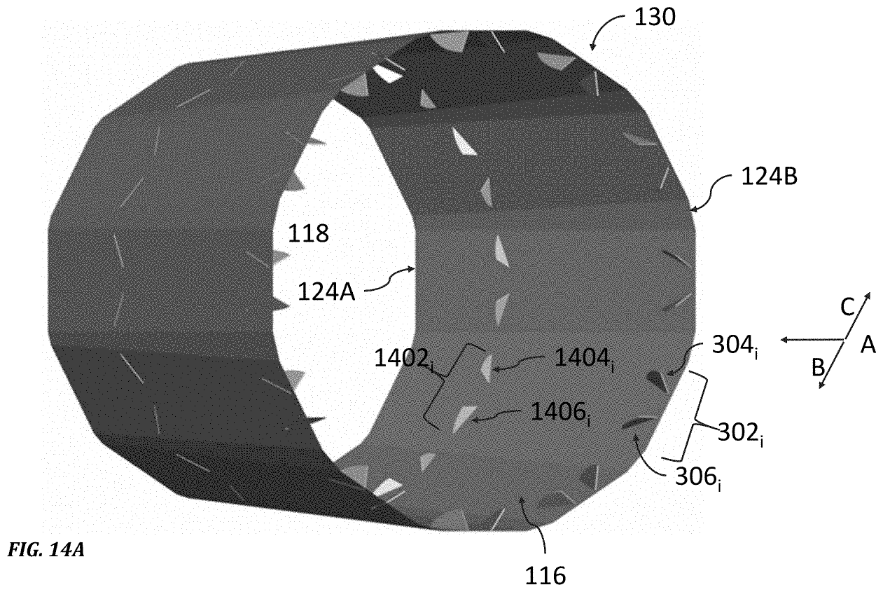

FIG. 13 illustrates the effect of varying the height (h) of the micro-vortex generators 304ᵢ and 306ᵢ when the nozzle pressure ratio is 2.7. As shown in FIG. 13, values greater than 0.043D_{nozzle} offer significant noise reduction, whereas a value of 0.025D_{nozzle} offers less noise reduction. Additional data shows that a preferred height (h) is 0.04D_{nozzle} or greater. However, increasing the height also increases the thrust penalty. So there is a balance between noise reduction performance and thrust penalty. In some embodiments, the thrust penalty may not be significant and thus the system designer or engineer is free to pick a blade height that is greater 0.04D_{nozzle}, such as a height in the range of 0.04D_{nozzle} to 0.06D_{nozzle}, inclusive. Of course, as one of ordinary skill will realized the optimal blade height depends on the specific configuration and the tolerance of the thrust penalty.

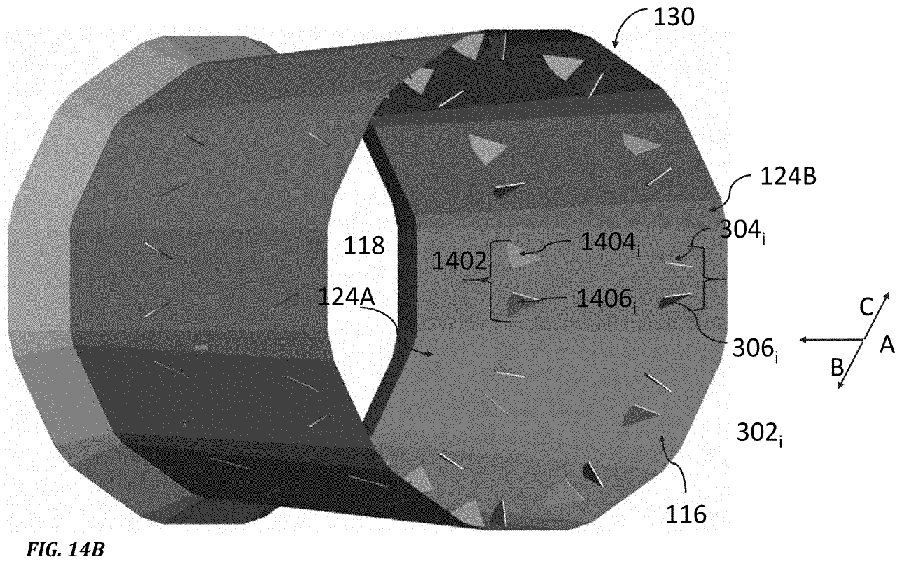

FIGS. 14A-B illustrate alternate embodiments where a second plurality of micro-vortex generator pairs 1402ᵢ may be disposed within the nozzle section 114 in addition to the plurality of micro-vortex generator pairs 302ᵢ. In the embodiment shown in FIG. 14A, the plurality of micro-vortex generator pairs 302ᵢ are disposed proximate to the nozzle exit 116, but upstream of the boundary-layer separation point. The second plurality of micro-vortex generator pairs 1402 are disposed at an axial distance of approximate −0.65D_{nozzle}. FIG. 14B shows a similar arrangement, but where the orientations of the pairs 302ᵢ are different form FIG. 14A. As can be seen in FIG. 14A, the plurality of micro-vortex generator pairs 302ᵢ and the second plurality of micro-vortex generator pairs 1402ᵢ are arranged in the configuration shown in FIGS. 8A and 8B, with their curved primary legs 402C disposed upstream and proximate to the throat 118. However, as is clear from FIGS. 14A and 14B, the angles a and b may be different for each of the plurality of micro-vortex generator pairs 302ᵢ and 1402ᵢ. For example, in FIG. 14A, the angle b for the plurality of micro-vortex generator pairs 302ᵢ is less than the angle b for the second plurality of micro-vortex generator pairs 1402ᵢ. Of course, this is merely exemplary. In another embodiment, the reverse is true and angle b for pairs 302ᵢ is greater than angle b for pairs 1402ᵢ. The plurality of micro-vortex generators 302ᵢ generate additional vortices that weaken the shock-cell structure, and stabilize the boundary layer near the nozzle exit 116. The array 302ᵢ helps to enhance the vortex generation and thus results additional the noise reduction. As one of ordinary skill will recognize, any or all of the principle variables l₁, h₁, w₁, dz, a, and b for the second plurality of micro vortex generator pairs 1402ᵢ may differ from those of the plurality of micro vortex generator pairs 302ᵢ. As discussed above, the principle variables may also vary from one pair of micro-vortex generators 302ᵢ to another pair of micro-vortex generators 302ⱼ where i and j are different. So too can any or all of the principle variables vary from one pair of the second plurality of micro-vortex generators 1402ᵢ to another pair of the second plurality of micro-vortex generators 1402ⱼ, where i and j are different.

While various example embodiments of the invention have been described above, it should be understood that they have been presented by way of example, and not limitation. It is apparent to persons skilled in the relevant art(s) that various changes in form and detail can be made therein. Thus, the disclosure should not be limited by any of the above described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized and navigated in ways other than that shown in the accompanying figures.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. An apparatus for directing combustion products from an engine, comprising:
a plurality of seals;
a plurality of flaps, wherein the plurality of seals and the plurality of flaps are interconnected and circumferentially arranged; and
a plurality of micro-vortex generators pairs respectively disposed in a circumferential manner on an interior surface of the plurality of seals, wherein each of the plurality of micro-vortex generator pairs includes: a first micro-vortex generator and a second micro-vortex generator.

2. The apparatus of claim 1, wherein the first micro-vortex generator is a scalene triangle comprising a first base leg, a first primary leg, and a first secondary leg, and wherein a length of the first secondary leg is less than or equal to a length of the first primary leg.

3. The apparatus of claim 2, wherein the base leg is attached to one of the plurality of seal surfaces.

4. The apparatus of claim 2, wherein the second micro-vortex generator is a scalene triangle comprising a second base leg, a second primary leg, and a second secondary leg, and wherein a length of the second secondary leg is less than or equal to a length of the second primary leg.

5. The apparatus of claim 1, wherein the first micro-vortex generator and the second micro-vortex generator are scalene triangles that each include a curved leg oriented upstream in a flow direction.

6. The apparatus of claim 2, wherein a height of the scalene triangle is greater than 0.025 times a diameter of a circumferential opening located at one end of the apparatus and formed by the plurality of seals and the plurality of flaps.

7. The apparatus of claim 2, wherein a distance between the first micro-vortex generator and the second micro-vortex generator is greater than 20% of a seal width.

8. The apparatus of claim 1, wherein a first angle between a face of the first micro-vortex generator and a seal surface on which the first micro-vortex generator is disposed is between 45 degrees and 145 degrees, inclusive.

9. The apparatus of claim 1, wherein a second angle between a face of the first micro-vortex generator and a face of the second micro-vortex generator is between 0 and 120 degrees, inclusive.

10. The apparatus of claim 1, wherein the second angle is between 25 and 50 degrees, inclusive.

11. The apparatus of claim 1, wherein a distance from a circumferential opening located at one end of the apparatus and formed by the plurality of seals and the plurality of flaps to a proximate portion of the plurality of micro-vortex generator pairs is between 80% and 30% of a seal length.

12. The apparatus of claim 1, wherein the first micro-vortex generator and the second micro-vortex generator are symmetrically arranged.

13. The apparatus of claim 1, wherein the first micro-vortex generator and the second micro-vortex generator are asymmetrically arranged.

13. A method of generating a plurality of vortices in a nozzle section of a jet engine, the comprising:
providing a plurality of micro-vortex generator pairs on a plurality of seal surfaces of the nozzle section, respectively, wherein each of the plurality of micro-vortex generator pairs is constructed to generate two vortices adjacent to an interior surface of the nozzle section and extending in a direction towards a nozzle exit,
wherein the vortices generated by the plurality of micro-vortex generator pairs reduce shock-cell strength within the nozzle section.
